(19) United States
(12) Patent Application Publication
(10) Pub. No.: US 2023/0129248 A1
(43) Pub. Date: Apr. 27, 2023

(54) ALTERNATIVE SHARED VEHICLE MONITORING AND ASSIGNMENT

(71) Applicant: HERE Global B.V., Eindhoven (NL)

(72) Inventor: Jerome Beaurepaire, Berlin (DE)

(21) Appl. No.: 17/507,220

(22) Filed: Oct. 21, 2021

(51) Int. Cl. G06Q 50/30; G06Q 10/06; G06Q 30/02; G01S 19/01

(52) U.S. Cl. CPC G06Q 50/30; G06Q 10/06312; G06Q 10/06313; G06Q 30/0201; G01S 19/01; G06Q 30/018

(57) ABSTRACT

A method and apparatus for assignment of a shared vehicle is described. The method includes receiving user location data, receiving booked shared vehicle data for a booked shared vehicle, determining booked shared vehicle suitability data using the user location data and the booked shared vehicle data, receiving alternative shared vehicle data for an alternative shared vehicle, determining an alternative shared vehicle suitability data using the user location data and the alternative shared vehicle data, and providing a notification to a user based on a comparison of the alternative shared vehicle suitability data to the booked shared vehicle suitability data.

### FIELD

The present application relates to shared vehicles and more particularly assignment of alternative shared vehicles.

### BACKGROUND

Shared vehicles are commonly used for transportation, particularly in urban environments. Shared vehicle providers allow a user to book (i.e., reserve) a vehicle for later use. For example, a user may reserve a vehicle while they travel to the vehicle, or a user may reserve a vehicle for use at a later time.

Shared vehicles may be used multiple times a day and are often left at the destination of a previous user. Accordingly, the availability of shared vehicles and different types of shared vehicles at a given location or within a given area may fluctuate frequently with many shared vehicles being taken from a given area and many shared vehicles arriving in the given area.

### SUMMARY

The following embodiments provide for assignment of an alternative shared vehicle using vehicle suitability data.

In one embodiment, a method for assignment of a shared vehicle includes receiving user location data, receiving booked shared vehicle data from a booked shared vehicle, determining booked shared vehicle suitability data for the booked shared vehicle using the user location data and the booked shared vehicle data, receiving alternative shared vehicle data for an alternative shared vehicle, determining an alternative shared vehicle suitability data using the user location data and the alternative shared vehicle data, and providing a notification to a user based on a comparison of the alternative shared vehicle suitability data to the booked shared vehicle suitability data.

In one embodiment, an apparatus for assignment of a shared vehicle includes a communication interface configured to receive user location data, booked shared vehicle data for a booked shared vehicle, and alternative shared vehicle data for an alternative shared vehicle. The apparatus further includes a memory configured to store the user location data, booked shared vehicle data, and alternative shared vehicle data. The apparatus includes a processor configured to access the memory, determine a booked shared vehicle suitability data using the user location data and booked shared vehicle data, determine an alternative shared vehicle suitability data using the user location data and the alternative shared vehicle data, and provide a notification to a user based on a comparison of the alternative shared vehicle suitability data to the booked shared vehicle suitability data.

In one embodiment, an apparatus for assignment of a shared vehicle includes a communication interface configured to receive user location data, booked shared vehicle data for a booked shared vehicle, and alternative shared vehicle data for an alternative shared vehicle. The apparatus further includes a memory configured to store the user location data, the booked shared vehicle data, and the alternative shared vehicle data. The apparatus includes a user interface and a processor configured to access the memory, determine a booked shared vehicle suitability data using the user location data and the booked shared vehicle data, and determine an alternative shared vehicle suitability data using the user location data and the alternative shared vehicle data. The user interface is configured to provide a notification to a user based on a comparison of the alternative shared vehicle suitability data to the booked shared vehicle suitability data.

### BRIEF DESCRIPTION OF THE DRAWINGS

Exemplary embodiments of the present disclosure are described herein with reference to the following drawings.

FIG. 1 is a view illustrating a system for assignment of a shared vehicle including a server, a network, and a mobile device according to an embodiment of the present disclosure.

FIG. 2 is a view illustrating a system for assignment of a shared vehicle including a server and a network according to an embodiment of the present disclosure.

FIG. 3 is a view illustrating a system for assignment of a shared vehicle including a mobile device and a network according to an embodiment of the present disclosure.

FIG. 4 is a view illustrating a system for assignment of a shared vehicle including a mobile device and a network according to an embodiment of the present disclosure.

FIG. 5 is a view illustrating a system for assignment of a shared vehicle according to an embodiment of the present disclosure.

FIG. 6 is a view illustrating a system for assignment of a shared vehicle according to an embodiment of the present disclosure.

FIG. 7 is a view illustrating a system for assignment of a shared vehicle according to an embodiment of the present disclosure.

FIG. 8 is a view illustrating a system for assignment of a shared vehicle according to an embodiment of the present disclosure.

FIG. 9 is a view of an apparatus for assignment of a shared vehicle according to an embodiment of the present disclosure.

FIG. 10 is a view of an apparatus for assignment of a shared vehicle according to an embodiment of the present disclosure.

FIG. 11 is an example flow chart for a method of assignment of a shared vehicle according to an embodiment of the present disclosure.

FIG. 12 is an example of a graphic user interface for an apparatus for assignment of a shared vehicle before a user has booked a shared vehicle according to an embodiment of the present disclosure.

FIG. 13 is an example of a graphic user interface for an apparatus for assignment of a shared vehicle in which a user has booked a shared vehicle according to an embodiment of the present disclosure.

FIG. 14 is an example of a graphical user interface for an apparatus for assignment of a shared vehicle in which an alternative shared vehicle has been identified according to an embodiment of the present disclosure.

FIG. 15 is an example of a graphical user interface for an apparatus for assignment of a shared vehicle in which an alternative shared vehicle has been assigned according to an embodiment of the present disclosure.

### DETAILED DESCRIPTION

Most commonly, users select a shared vehicle from one or more shared vehicles through a ride sharing application on a mobile device (i.e., smartphone). When selecting a shared vehicle, the user typically selects from the available shared vehicles on a given application. Often, the riding sharing application displays shared vehicles within a given vicinity of the mobile device. For example, a ride sharing application may display all available shared vehicles within 1000 feet of the mobile device. The ride sharing application may display one or more different types of shared vehicles.

Embodiments of the present disclosure relate to the assignment of an alternative shared vehicle after a user has already booked a shared vehicle. Shared vehicles include any moving vehicle, device, machine, instrument, apparatus, or the like capable of transporting a user and being shared by multiple users. Examples of a shared vehicle include automobiles, motorcycles, mopeds, motorized or unmotorized bicycles, motorized or unmotorized scooters, motorized or unmotorized skateboards, and the like.

In some embodiments, the methods, and apparatuses for the assignment of shared vehicles as disclosed herein may utilize one or more applications, programs, or software for to perform one or more functions or operations of the method or apparatus. Such applications, programs, or software may be connected to a network, such as the internet, and may be implemented on one or more devices or apparatuses, such as a server and/or a mobile device (e.g., a smartphone).

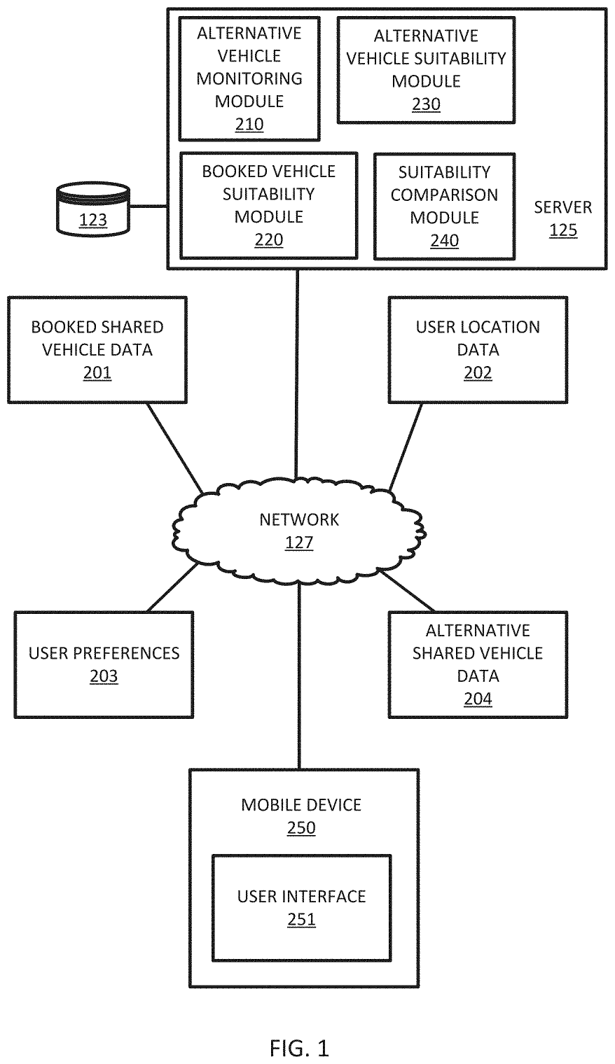

FIG. 1 illustrates a system for assignment of a shared vehicle according to an embodiment of the present disclosure. The system of FIG. 1 includes a network 127 connecting a server 125 and a mobile device 250. In some embodiments, the network 127 is connected to more than one mobile device 250.

The network 127 connects the server 125 and the mobile device 250 and may be used for the exchange of information/data between the server 125 and the mobile device 250. The network 127 may be the internet and/or other networks. Additionally, booked shared vehicle data 201, user location data 202, user preferences 203, and alternative shared vehicle data 204 are all accessible by the network 127. The booked shared vehicle data 201, user location data 202, user preferences 203, and alternative shared vehicle data 204 may be accessed through one or more application program interfaces communicating with one or more applications or programs.

The booked shared vehicle data 201, user location data 202, user preferences 203, and alternative shared vehicle data 204 may be stored on one or more devices connected to the network 127. In some embodiments the booked shared vehicle data 201, the user location data 202, the user preferences 203, and the alternative shared vehicle data 204 are stored on the mobile device 250. In other embodiments, the booked shared vehicle data 201, the user location data 202, the user preferences 203, and the alternative shared vehicle data 204 may be stored on one or more servers 125. The booked shared vehicle data 201, the user location data 202, the user preferences 203, and the alternative shared vehicle data 204 may be accessed through one or more application program interfaces (APIs).

The booked shared vehicle data 201 may include a booked shared vehicle location, a booked shared vehicle type, a booked shared vehicle price, a destination of the user, a distance from the booked shared vehicle to the destination, routes that the booked shared vehicle is capable of taking, a booked shared vehicle safety rating, a booked shared vehicle range, features of the booked shared vehicle (e.g., a sunroof), how and where the user is able to park the book shared vehicle once it reaches the destination, and the like. The booked shared vehicle data 201 may be provided by an API connected to a ride sharing application used to book the booked shared vehicle.

The user location data 202 includes a location of the user and may include weather at the location of the user. The user location data 202 may be provided by an API connected to a ride sharing application used to book the booked shared vehicle.

The user preferences 203 may include a preferred vehicle type, a preferred vehicle provider, a preferred vehicle route, preference for a least expensive shared vehicle, a preferred vehicle safety rating, and the like. Further, the user preferences 203 may include a preferred feature of the shared vehicle, for example, a user may prefer a vehicle type of an automobile and that the automobile have a feature consisting of a sunroof. The user preferences 203 may be provided by an API communicating with a ride sharing application used to book the booked shared vehicle.

The alternative shared vehicle data 204 may include an alternative shared vehicle location, an alternative shared vehicle type, an alternative shared vehicle price, a destination of the user, a distance from an alternative shared vehicle to a destination, routes that the alternative shared vehicle is capable of taking, an alternative shared vehicle safety rating, an alternative shared vehicle range, features of the alternative shared vehicle (e.g., a sunroof), how and where the user is able to park the alternative shared vehicle on it reaches the destination, and the like. The alternative shared vehicle data 204 may be provided by an API in communication with an application that may be used to reserve the alternative shared vehicle.

In the embodiment of FIG. 1, the server 125 includes an alternative vehicle monitoring module 210, a booked vehicle suitability module 220, an alternative vehicle suitability module 230, and a suitability comparison module 240.

The alternative vehicle monitoring module 210 monitors for alternative shared vehicles. The alternative vehicle monitoring module 210 may be configured to monitor a vicinity surrounding a user. For example, the alternative vehicle monitoring module 210 may monitor for alternative shared vehicles within 1000 feet of the user. The alternative vehicle monitoring module 210 may be in communication with one or more ride sharing applications. The alternative vehicle monitoring module 210 may communicate with the one or more ride sharing applications through one or more APIs. The one or more ride sharing applications may inform the alternative vehicle monitoring module 210 when an alternative shared vehicle becomes available.

The booked vehicle suitability module 220 determines the booked shared vehicle suitability data for a booked shared vehicle. The booked vehicle suitability module 220 receives the booked shared vehicle data 201 and user location data 202. The booked shared vehicle data 201 and the user location data 202 may be received from one or more ride sharing applications.

The booked vehicle suitability module 220 determines the booked shared vehicle suitability data using the booked shared vehicle data 201 and the user location 202. In some embodiments the booked vehicle suitability module 220 may receive user preferences 203 from one or more ride sharing applications and/or a user's mobile device 250. The booked vehicle suitability module 220 may determine the booked shared vehicle suitability data using the booked shared vehicle data 201, the user location data 202, and the user preferences 203.

Additionally, the booked vehicle suitability module 220 may be configured to determine inputs and/or components used to determine the booked vehicle suitability data. For example, the booked vehicle suitability module 220 may receive a booked vehicle location and a destination location, from the booked shared vehicle data 201, and a user location from the user location data 202. The booked vehicle suitability module 200 may then determine whether a detour must be taken for the user to reach the booked shared vehicle and a length of the detour. Whether a detour must be taken to reach the booked shared vehicle and the length of the detour may then be used by the booked vehicle suitability module 220 to determine the booked vehicle suitability data.

The alternative vehicle suitability module 230 determines the alternative shared vehicle suitability data for the alternative shared vehicle. The alternative vehicle suitability module 230 receives the alternative shared vehicle data 204 and the user location data 202. The alternative shared vehicle data 204 and the user location data 203 may be received from one or more ride sharing applications.

The alternative vehicle suitability module 230 determines the alternative shared vehicle suitability data using the alternative shared vehicle data 204 and the user location data 202. In some embodiments, the alternative vehicles suitability module 230 may also receive user preferences 203 from one or more ride sharing applications and/or a user's mobile device. The alternative shared vehicle module 230 may determine the alternative shared vehicle suitability data using the alternative shared vehicle data 204, the user location data 202, and the user preferences 203.

The alternative vehicle suitability module 230 may be configured to determine inputs and/or components used to determine the alternative vehicle suitability data. For example, the alternative vehicle suitability module 230 may receive the alternative vehicle location in the alternative shared vehicle data 204, a destination in the booked shared vehicle data 201, and a user location from the user location data 202. The alternative vehicle suitability module 230 may then determine whether a detour must be taken for the user to reach the alternative shared vehicle and a length of the detour. Whether a detour must be taken to reach the alternative shared vehicle and a length of the detour may then be used to determine the alternative shared vehicle suitability data.

The booked vehicle suitability module 220 and the alternative vehicle suitability module 230 may determine the booked vehicle suitability data and the alternative vehicle suitability data using a relevance score. The relevance score is determined using inputs from the user location data 202 and the booked shared vehicle data 201 or the alternative shared vehicle data 204. In some embodiments the user preferences 203 are also used as inputs to determine the relevance score.

The relevance score may consider the following inputs in determining the relevance score: a distance from the user to a booked shared vehicle or alternative shared vehicle, if a detour needs to be taken to reach the booked shared vehicle or alternative shared vehicle and the length of the detour if necessary, the type of the booked shard vehicle or alternative shared vehicle, a comfort score associated with the booked shared vehicle or alternative shared vehicle, the weather at the location of a user, a distance from the user to the destination, a price of the booked shared vehicle or alternative shared vehicle, routes that the booked shared vehicle or alternative shared vehicle are capable of taking, how and where the user is able to park the booked shared vehicle or alternative shared vehicle at the destination, a safety score associated with the booked shared vehicle or alternative shared vehicle, a user's preference (e.g., a user's preference for a certain type of shared vehicle or that a vehicle include a certain feature), a range of the booked shared vehicle or alternative shared vehicle, and the like.

The various inputs used to calculate the relevance score are weighted and added together to determine the relevance score for the booked shared vehicle or alternative shared vehicle. The various inputs used to determine the relevance score may be selected by the user. The user may determine the weights associated with each input. In some embodiments the booked vehicle suitability module 220 and the alternative vehicle suitability module 230 determine the inputs and the weights assigned to each input. When the booked vehicle suitability module 220 and the alternative vehicle suitability module 230 determine the inputs and their respective weights, the booked vehicle suitability module 220 and the alternative vehicle suitability module 230 use the same inputs and weights. The booked vehicle suitability module 220 and the alternative vehicle suitability module 230 may determine the inputs and their weighs with or without the user preferences 203.

Alternatively, the booked vehicle suitability module 220 and the alternative vehicle suitability module 230 may determine the booked vehicle suitability data and the alternative vehicle suitability data using a relevance vector. The relevance vector is determined using components from the user location data 202 and the booked shared vehicle data 201 or the alternative shared vehicle data 204. In some embodiments the user preferences 203 are also used as components to determine the relevance vector.

The relevance vector may consider the following components in determining the relevance vector: a distance from the user to a booked shared vehicle or alternative shared vehicle, if a detour needs to be taken to reach the booked shared vehicle or alternative shared vehicle and the length of the detour if necessary, the type of the booked shard vehicle or alternative shared vehicle, a comfort score associated with the booked shared vehicle or alternative shared vehicle, the weather at the location of a user, a distance from the user to the destination, a price of the booked shared vehicle or alternative shared vehicle, routes that the booked shared vehicle or alternative shared vehicle are capable of taking, how and where the user is able to park the booked shared vehicle or alternative shared vehicle at the destination, a safety score associated with the booked shared vehicle or alternative shared vehicle, a user's preference (e.g., a user's preference for a certain type of shared vehicle or that a vehicle include a certain feature), a range of the booked shared vehicle or alternative shared vehicle, and the like.

In some embodiments, a user may select the components used to determine the relevance vector. In other embodiments the booked vehicle suitability module 220 and the alternative shared vehicle suitability module 230 may determine the components used to determine the relevance vector. In embodiments where the booked vehicle suitability module 220 and the alternative shared vehicle suitability module 230 determine the components, the components used by the booked shared vehicle suitability module 220 and the alternative shared vehicle suitability module 230 are the same.

In some embodiments, the components used to determine the relevance vector may have a magnitude, that is the components of the relevance vector may be weighted. The components may be weighted by a user or by the booked shared vehicle suitability module 220 and the alternative shared vehicle suitability module 230. If the magnitude of the components is determined using the booked vehicle suitability module 220 and the alternative shared vehicle suitability module 230, the magnitudes for each input may be the same. The booked vehicle suitability module 220 and the alternative shared vehicle suitability module 230 may determine the magnitude of the components with or without the user preferences 203.

The components of the relevance vector may individually or collectively determine the relevance vector for the booked shared vehicle or alternative shared vehicle. The relevance vector is indicative of the suitability of the booked shared vehicle or the alternative shared vehicle.

For example, if a detour needs to be taken to reach an alternative shared vehicle the component for the length of the detour may alone determine the relevance vector for an alternative shared vehicle. Specifically, if the length of a detour to reach an alternative shared vehicle is longer than a predetermined length, the component for the length of the detour may alone determine the relevance vector and the relevance vector may indicate that the alternative shared vehicle is not suitable.

In another example, if the user location data indicates that it is raining and an alternative shared vehicle data indicates that an alternative shared vehicle has a roof, and thus will keep a user dry, the weather component and the alternative shared vehicle type component are sufficient to determine the relevance vector and that the alternative shared vehicle is suitable.

The relevance score and relevance vector for the booked shared vehicle and alternative shared vehicle are determined using the same criteria. In other words, the same weights and inputs are used to determine the relevance score and the same rules and components are used to determine the relevance vector.

The suitability comparison module 240 compares the booked vehicle suitability data and the alternative vehicle suitability data.

Accordingly, in the embodiment of FIG. 1, the server 125 performs the functionality of the alternative vehicle monitoring module 210, the booked vehicle suitability module 220, the alternative vehicle suitability module 230, and the suitability comparison module 240.

When the booked vehicle suitability data and the alternative vehicle suitability data are determined using a relevance score the suitability comparison module 240 may determine whether the booked shared vehicle or the alternative shared vehicle has a higher relevance score.

In some embodiments where the booked vehicle suitability data and the alternative vehicle suitability data comprise a relevance score, if the relevance score of the alternative shared vehicle exceeds the relevance score of the booked shared vehicle a notification may be provided to a user that an alternative shared vehicle is more suitable. In other embodiments, a notification may only be sent if the relevance score of the alternative shared vehicle exceeds the relevance score of the booked shared vehicle by at least some threshold. For example, a notification may be sent only if the alternative shared vehicle relevance score exceeds the booked shared relevance score by ten or more points.

When the booked vehicle suitability data and the alternative vehicle suitability data are determined using a relevance vector, the suitability comparison module 240 may determine whether the alternative vehicle relevance vector and the booked vehicle relevance vector are suitable. When the alternative vehicle relevance vector indicates that the alternative shared vehicle is suitable and the booked vehicle relevance vector indicates that the booked shared vehicle is not suitable, a notification may be sent to the user. A notification may only be sent to a user if an alternative shared vehicle relevance vector indicates that the alternative shared vehicle is suitable and if a booked shared vehicle relevance vector indicates that the booked shared vehicle is not suitable.

In some embodiments, when a notification is sent to a user, in embodiments where either/or both relevance score and relevance vectors are used, the notification may inform the user that an alternative shared vehicle that is more suitable than the booked shared vehicle is available. The notification that an alternative shared vehicle is available may provide a user with an option to reserve the alternative shared vehicle or to keep the booked shared vehicle.

The notification that an alternative shared vehicle is available may bring the user to a ride sharing application. In some embodiments, the ride sharing application may be a ride sharing application used to book the booked shared vehicle (i.e., an application of a first ride share provider). In other embodiments, the ride sharing application may be a ride sharing application used to reserve the alternative shared vehicle (i.e., an application of a second ride share provider). In some embodiments the booked shared vehicle and alternative shared vehicle may both be provided by the same ride share application, in this case, the ride sharing application may be that of both the booked shared vehicle and the alternative shared vehicle. In other embodiments, a ride share application may aggregate available shared vehicles from multiple ride share applications and/or ride share providers. In this case, the notification may bring a user to the ride share application that aggregates shared vehicles from one or more applications and/or one or more ride share providers. The user may then reserve the alternative shared vehicle and cancel the booked shared vehicle from the ride sharing application that aggregates shared vehicles from one or more applications and/or providers.

After selecting the notification and arriving at a ride sharing application, the user may cancel the booked shared vehicle and/or reserve the alternative shared vehicle. In some embodiments, the application may display one or more of the inputs or components used to determine the booked vehicle suitability data and the alternative vehicle suitability data to the user through the application. Inputs and/or components for the booked shared vehicle and alternative shared vehicle may be displayed side by side.

In other embodiments, the alternative shared vehicle may automatically be reserved, and the notification may inform that user that an alternative shared vehicle has been reserved. When the alternative shared vehicle is automatically reserved the booked shared vehicle may also be automatically cancelled. The notification that an alternative shared vehicle has been booked may bring the user to a ride share application. The ride share application may be the ride share application associated with the booked shared vehicle, the ride share application associated with the alternative shared vehicle, or a ride share application that aggregates shared vehicles from one or more ride share applications and/or ride share providers.

A notification sent to a user may be sent to a user's mobile device 250. The mobile device 250 is connected to the server 125 via the network 127. The user device may have a user interface 251. In some embodiments, the mobile device 250 may be a smartphone. The notification may be sent to a user through the mobile device 250. A user may interact with the notification and one or more applications through the user interface 251.

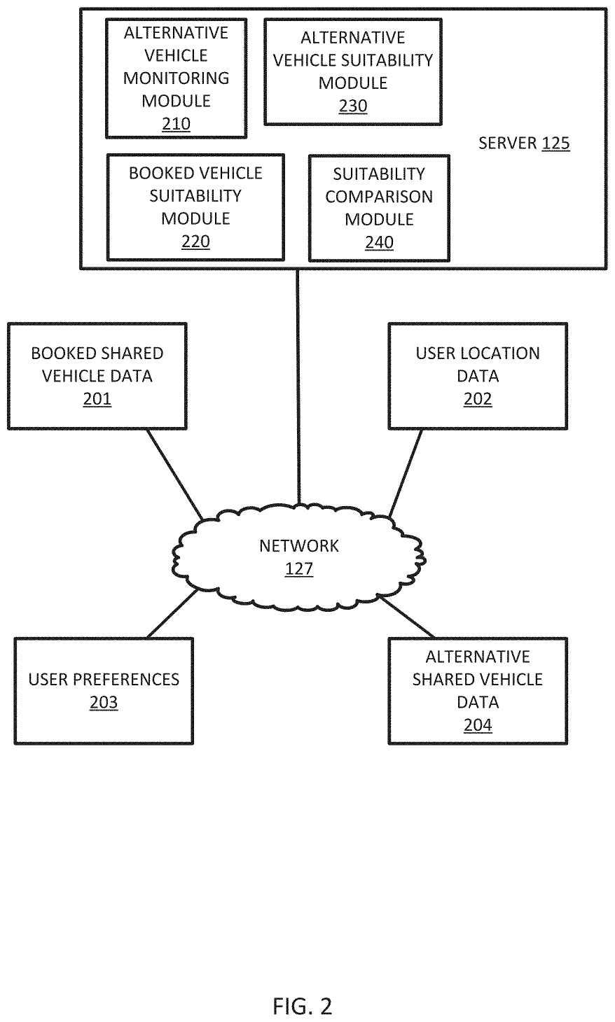

FIG. 2 illustrates a system for assignment of a shared vehicle according to another embodiment of the present disclosure. The system of FIG. 2 includes a server 125 and a network 127. The server 125 includes an alternative vehicle monitoring module 210, a booked vehicle suitability module 220, an alternative vehicle suitability module 230, and a suitability comparison module 240. The network 127 is connected to the server 125, booked shared vehicle data 201, user location data 202, user preferences 203, and alternative shared vehicle data 204.

The server 125 and network 127 and their respective subcomponents (the alternative vehicle monitoring module 210, the booked vehicle suitability module 220, the alternative vehicle suitability module 230, and the suitability comparison module 240) may be the same as those discussed above with respect to FIG. 1. Additionally, the booked shared vehicle data 201, user location data 202, user preferences 203, and alternative shared vehicle data 204 as illustrated in FIG. 2 may be the same as those discussed above with respect to FIG. 1. Accordingly, a detailed description of these elements with respect to FIG. 2 is omitted.

The system for assignment of a shared vehicle of FIG. 2 is similar to the system for assignment of a shared vehicle as discussed with respect to the embodiment of FIG. 1; however, the system for assignment as embodied in FIG. 2 does not include a mobile device 250. In the embodiment of FIG. 2, the server 125 may include a user interface to provide a notification to a user. Additionally, the server 125 may communicate with one or more electronic devices through the network 127. The one or more electronic devices may provide a notification to a user. Such electronic devices include personal computers, public computers, tablets, smartphones, and the like.

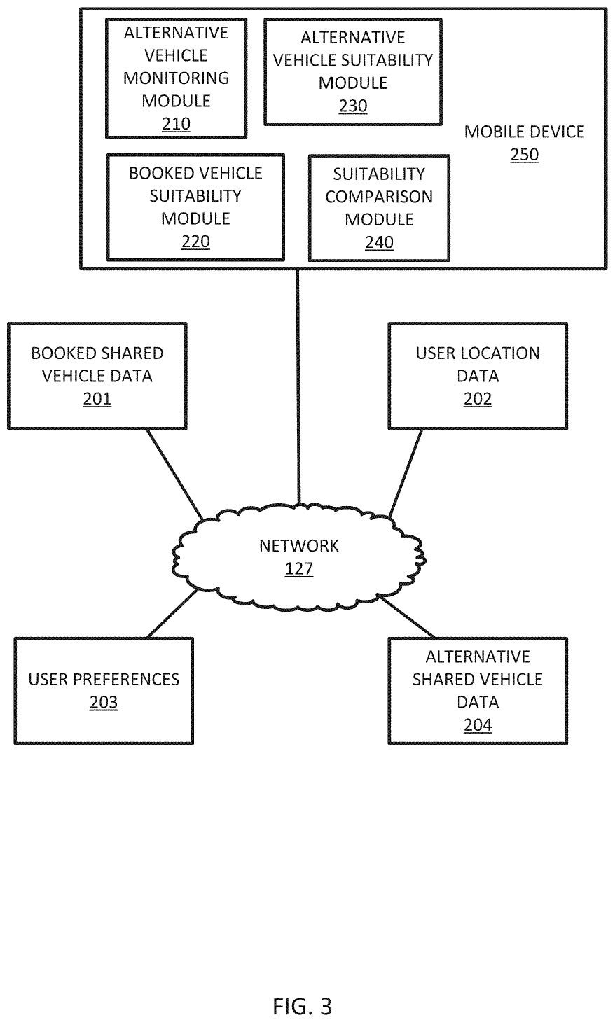

FIG. 3 illustrates a system for assignment of a shared vehicle according to another embodiment of the present disclosure. The system of FIG. 3 includes a mobile device 250, a network 127, booked shared vehicle data 201, user location data 202, user preferences 203, and alternative shared vehicle data 204. The network 127, booked shared vehicle data 201, user location data 202, user preferences 203, and alternative shared vehicle data 204 as provided in the embodiment of FIG. 3 may be the same as those provided in the embodiments of FIGS. 1 and 2. Accordingly, a detailed description of these elements with respect to FIG. 3 is omitted.

The mobile device 250, in the embodiment of FIG. 3, includes an alternative vehicle monitoring module 210, a booked vehicle suitability module 220, an alternative vehicle suitability module 230, and a suitability comparison module 240. The alternative vehicle monitoring module 210, the booked vehicle suitability module 220, the alternative vehicle suitability module 230, and the suitability comparison module 240 as provide in the embodiment of FIG. 3 may be the same as those of FIGS. 1 and 2; however, in the embodiment of FIG. 3, these modules are contained in the mobile device 250.

Accordingly, in the embodiment of FIG. 3, the mobile device 250 performs the functionality of the alternative vehicle monitoring module 210, the booked vehicle suitability module 220, the alternative vehicle suitability module 230, and the suitability comparison module 240. In other words, the mobile device may monitor for alternative shared vehicles, may determine the booked shared vehicle and alternative shared vehicle suitability data, and may compare the booked vehicle suitability data and the alternative shared vehicle suitability data.

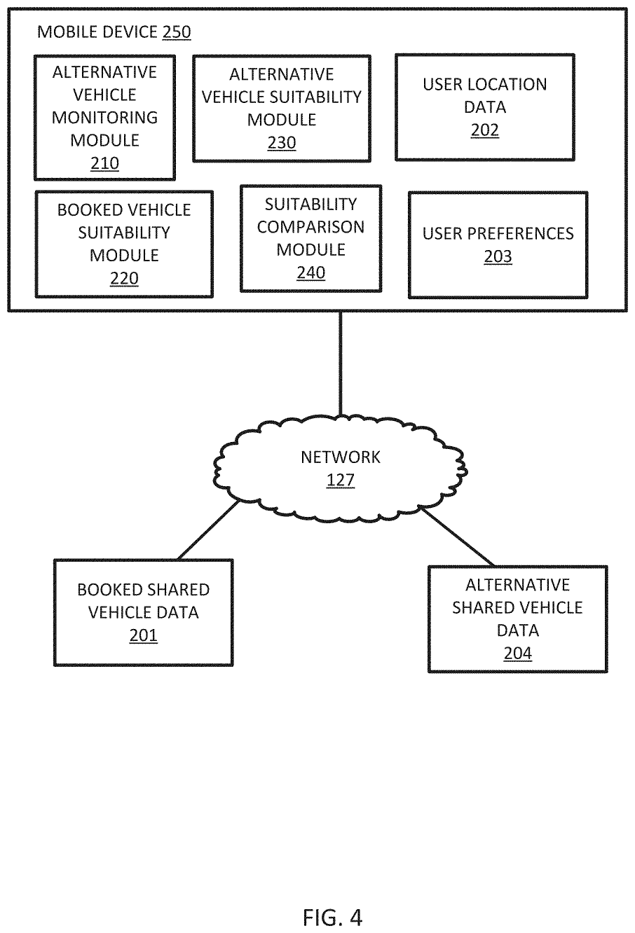

FIG. 4 illustrates a system for assignment of a shared vehicle according to another embodiment of the present disclosure. The system according to the embodiment of FIG. 4 includes a mobile device 250, a network 127, booked shared vehicle data 201 and alternative shared vehicle data 204.

The system of FIG. 4 includes a mobile device 250, a network 127, booked shared vehicle data 201, user location data 202, user preferences 203, and alternative shared vehicle data 204. The network 127, booked shared vehicle data 201, user location data 202, user preferences 203, and alternative shared vehicle data 204 as provided in the embodiment of FIG. 4 may be the same as those provided in the embodiments of FIGS. 1-3. Accordingly, a detailed description of these elements with respect to FIG. 4 is omitted.

In the embodiment of FIG. 4, the alternative vehicle monitoring module 210, the booked vehicle suitability module 220, the alternative vehicle suitability module 230, and the suitability comparison module 240 are located in the mobile device 250. Accordingly, the mobile device performs the functionality and/or operations of the alternative vehicle monitoring module 210, the booked vehicle suitability module 220, the alternative vehicle suitability module 230, and the suitability comparison module 240.

Additionally, in the embodiment of FIG. 4, the user location data 202 and the user preferences 203 are contained within the mobile device 250. Accordingly, the user location data 202 and/or the user preferences may be determined or obtained by the mobile device 250 and/or stored by the mobile device 250.

The mobile device 250 may determine the user location data 202 using position circuitry. The position circuitry may collect global navigation satellite system (GNSS) location data of the mobile device 250. The position circuitry may generate GNSS location data (i.e., user location data) by receiving GNSS signals and comparing the GNSS signals to a clock to determine the absolute or relative position of the mobile device 250.

The mobile device 250 may obtain the user preferences 203 directly from the user. The user may input user preferences into the mobile device 250 through a user interface on the mobile device. The user interface may include a screen. The user interface may include a touch sensitive surface (i.e., a touch screen) and/or or one or more buttons for the user to input the user preferences 203. The user interface may be configured to receive user preferences said orally by a user of the mobile device 250.

In some embodiments, the mobile device 250 may determine user preferences 203 from past trip information stored in the mobile device 250. The past trip information may include past user preferences 203 input to the mobile device and/or booked vehicle data 201 and alternative shared vehicle data 204.

The mobile device 250 may be configured to store the user location data 202 and the user preferences 203.

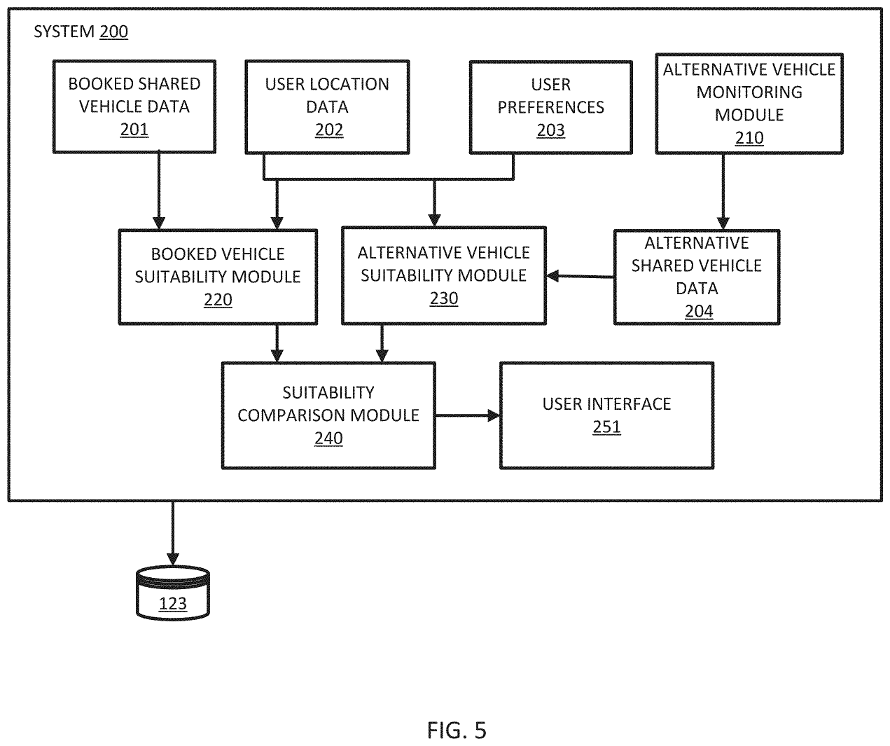

FIG. 5 illustrates a system 200 for assignment of a shared vehicle according to another embodiment of the present disclosure. The system 200 includes booked shared vehicle data 201, user location data 202, and alternative shared vehicle data 204. In some embodiments the system 200 may include user preferences 203. The system 200, further includes an alternative vehicle monitoring module 210, a booked vehicle suitability module 220, an alternative vehicle suitability module 230, and a suitability comparison module 240. The system 200 may further include a user interface 251 and/or a database 123.

The booked shared vehicle data 201, user location data 202, user preferences 203, and alternative shared vehicle data 204 of the embodiment of FIG. 5 may be the same as those of FIGS. 1-4. Accordingly, a detailed description of these elements with respect to FIG. 5 is omitted.

In the embodiment of FIG. 5, the alternative vehicle monitoring module 210, the booked shared vehicle suitability module 220, the alternative shared vehicle suitability module 230, and the suitability comparison module 240 may be the same as those described with respect to FIGS. 1-4. Accordingly, a detailed description of these elements with respect to FIG. 5 is omitted.

In the embodiment of FIG. 5, the alternative vehicle monitoring module 210 monitors for alternative shared vehicles. When an alternative shared vehicle is identified, the system receives the alternative shared vehicle data 204. The alternative vehicle suitability module 230 receives the alternative shared vehicle data 204. The alternative shared vehicle suitability module 230 additionally receives the user location data 202. In some embodiments, the alternative vehicle suitability 230 also receives the user preferences 203. The alternative vehicle suitability module 230 determines the alternative vehicle suitability data using the alternative vehicle data and the user location data 202. In some embodiments the alternative vehicle suitability module 230 may determine the alternative shared vehicle data using the user preferences 203. The alternative shared vehicle may comprise a relevance score and/or a relevance vector.

The booked vehicle suitability module 220 receives the booked shared vehicle data 201 and the user location data 202. In some embodiments, the booked vehicle suitability module receives the user preferences 203. The booked vehicle suitability module determines the booked vehicle suitability data using the booked shared vehicle data 201 and the user location data 202. In some embodiments, the booked vehicle suitability module 220 may determine the booked vehicle suitability data using the user preferences 203. The booked vehicle suitability data may include a relevance score and/or a relevance vector.

The suitability comparison module 240 receives the booked vehicle suitability data and the alternative vehicle suitability data. The suitability comparison module 240 compares the booked vehicle suitability data and the alternative vehicle suitability data. The suitability comparison module 240 may compare the booked vehicle suitability data and the alternative vehicle suitability data as disclosed herein with reference to the embodiment of FIG. 1.

If the suitability comparison module 240 determines that a notification is to be provided to the user, a notification may be provided to the user through the user interface 251. Such a notification may inform a user that an alternative shared vehicle has been reserved or may provide the user with an option to keep a booked shared vehicle or reserve an alternative shared vehicle. The user interface 251 may be operable to allow a user to select whether the booked shared ride is kept of whether an alternative shared vehicle is reserved.

In some embodiments the system 200 includes a database 123. The database 123 may be used to store the booked shared vehicle data 201, the user location data 202, the user preferences 203, the alternative shared vehicle data 204, the booked vehicle suitability, the alternative vehicle suitability, and/or whether a user selected to keep a booked shared vehicle or reserve an alternative shared vehicle.

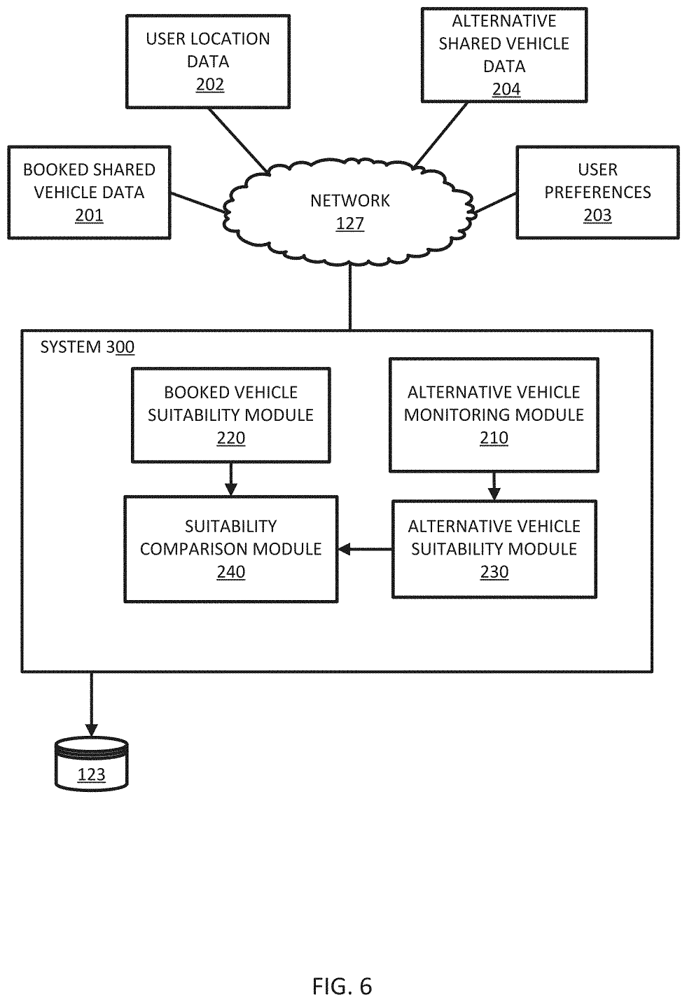

FIG. 6 illustrates a system 300 for assignment of a shared vehicle according to another embodiment of the present disclosure. In the embodiment of FIG. 6, the system 300 contains an alternative vehicle monitoring module 210, a booked vehicle suitability module 220, an alternative vehicle suitability module 230, and a suitability comparison module 240. The network 127, in the embodiment of FIG. 6, is connected to the system 300, booked shared vehicle data 201, user location data 202, user preferences 203, and alternative shared vehicle data 204. The system 300 may further be connected to a database 123. The network 127 may further be connected to a mobile device 250. The mobile device 250 may be operable to allow a user to interact with the system 300 via the network 127.

The alternative vehicle monitoring module 210, the booked vehicle suitability module 220, the alternative vehicle suitability module 230, and the suitability comparison module 240 of the system 300 may be the same as those discussed with respect to the embodiments of FIGS. 1-5. Additionally, the network 127, booked shared vehicle data 201, user location data 202, user preferences 203, and alternative shared vehicle data 204 may be the same as those discussed with respect to the embodiments of FIGS. 1-5.

In the embodiment of FIG. 6, the network 127 is connected to the booked shared vehicle data 201, the user location data 202, the user preferences 203, the alternative shared vehicle data 204, and the system 300. The system 300 may receive the booked shared vehicle data 201, the user location data 202, the user preferences 203, and the alternative shared vehicle data 204 from the network. The booked shared vehicle data 201, the user location data 202, the user preferences 203, and the alternative shared vehicle data 204 may come from a mobile device. The booked shared vehicle data 201, the user location data 202, the user preferences 203, and the alternative shared vehicle data 204 may come from one or more ride share applications and/or ride share providers.

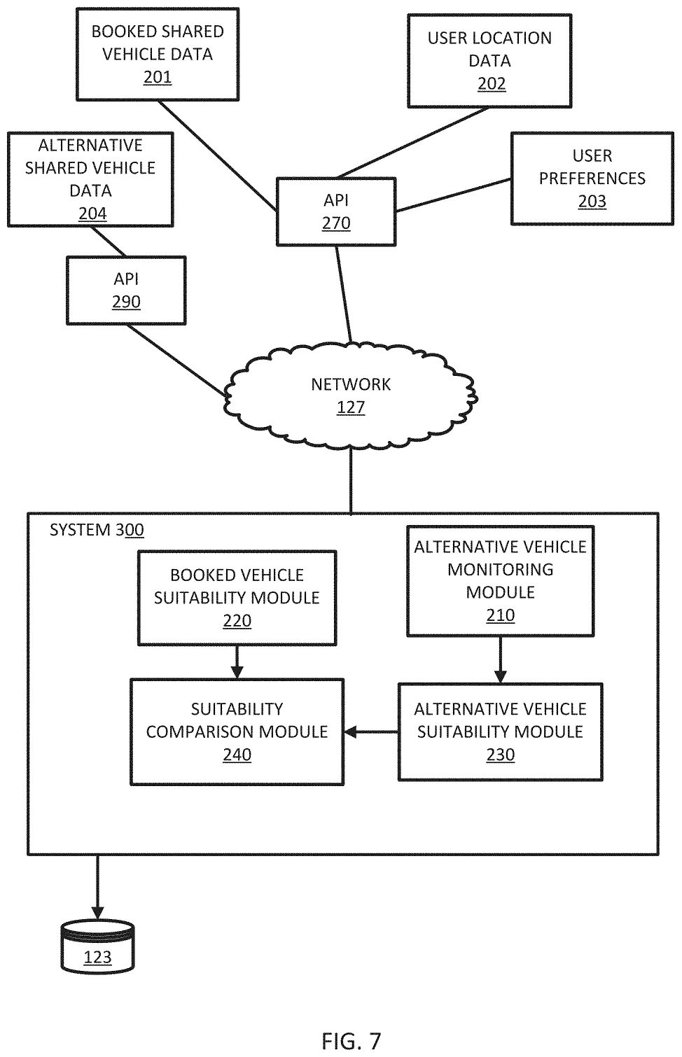

FIG. 7 illustrates an embodiment of the system 300 and network 127 in which the network 127 is connected to application program interfaces (API) 270 and 290. In the embodiment as illustrated by FIG. 7, the system 300 and API 270 and 290 may communicate via the network 127. In some embodiments, one or more mobile devices may be connected to the network 127 and may communicate via the network 127.

The API 270 is connected to the network 127, the booked shared vehicle data 201, the user location data 202, and the user preferences 203. In this embodiment the API 270 may receive the booked shared vehicle data 201, the user location data 202, and the user preferences from a ride sharing application. The ride sharing application may be an application on which a user booked the booked shared vehicle. The ride sharing application may include the user location data 202 and user preferences 203 used to book the booked shared vehicle and the booked shared vehicle data 201.

The API 290 is connected to the network 127 and the alternative shared vehicle data 204. In this embodiment, the API 290 may receive the alternative shared vehicle data 204 from a ride sharing application, the ride sharing application may be a ride sharing application which is used to reserve the alternative shared vehicle.

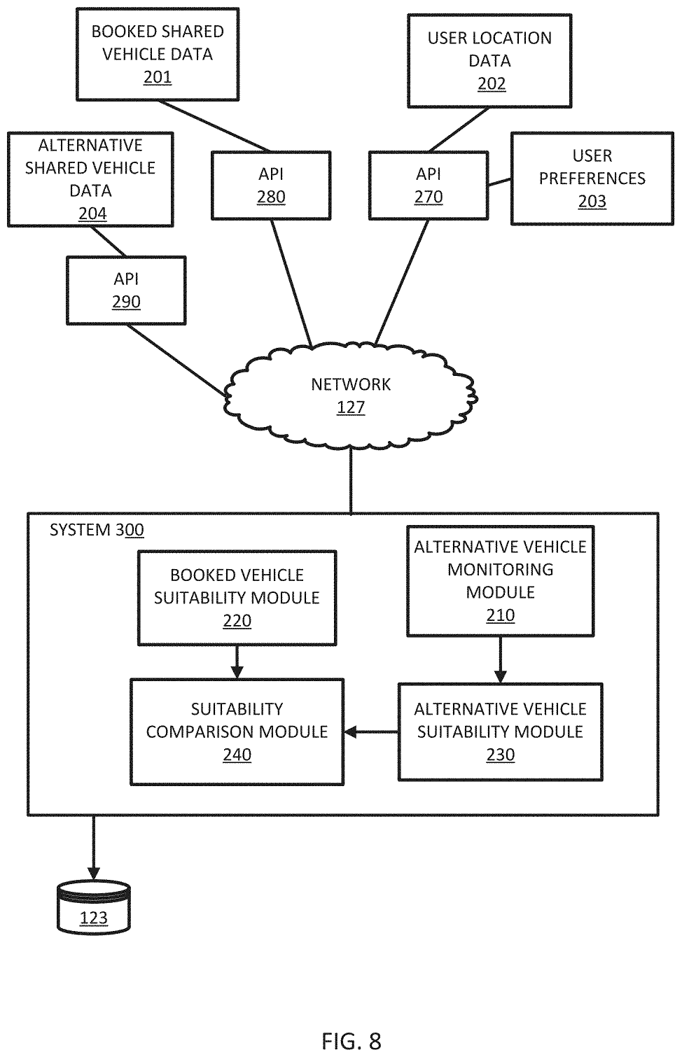

FIG. 8 illustrates an embodiment in which a network 127 connects the system 300 and three API 270, 280, and 290. The system 300 and API 270, 280, and 290 may communicate via the network 127.

The API 270 is connected to the network 127 and the user location data 202 and user preferences 203. In this embodiment, the API 270 may be connected to a ride sharing application that aggregates shared vehicles from one or more ride sharing application and/or one or more ride sharing providers.

The API 280 is connected to the network 127 and the booked shared vehicle data 201. In this embodiment, the API 280 may be connected to a ride sharing application. The ride sharing application may be a ride sharing application used to book the booked shared vehicle.

The API 290 is connected to the network 127 and the alternative shared vehicle data 204. In this embodiment, the API 290 may be connected to a ride sharing application. The ride sharing application may be a ride sharing application used to book an alternative shared vehicle.

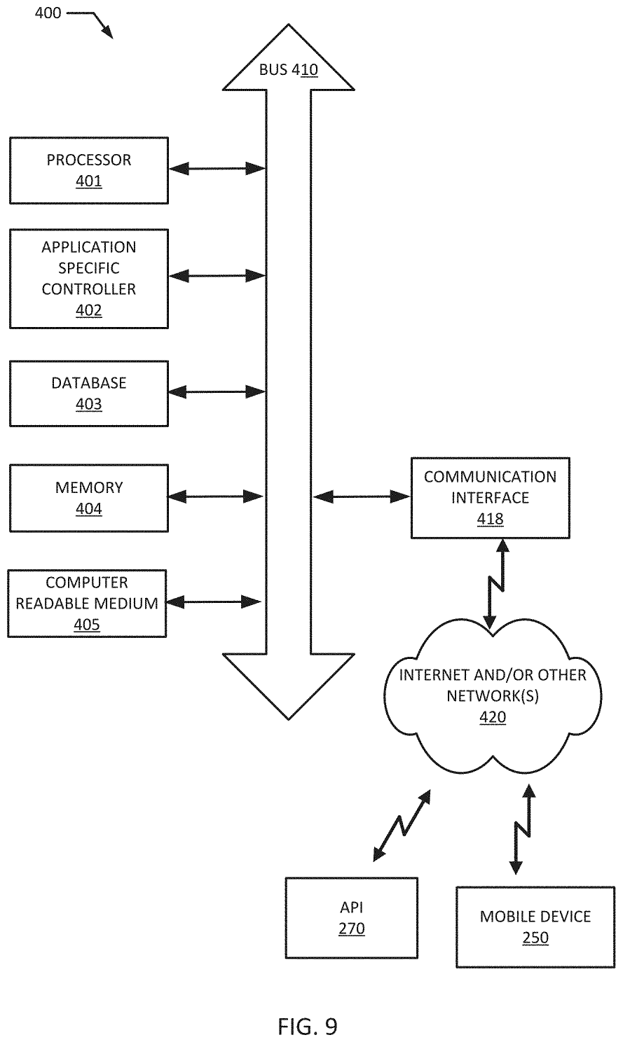

FIG. 9 illustrates an apparatus 400 for assignment of a shared vehicle according to an embodiment of the present disclosure. The apparatus 400 includes a bus 410 facilitating communication between a controller that may be implemented by a processor 401 and/or an application specific controller 402, which may be referred to individually or collectively as the controller, and one or more components including a database 403, a memory 404, a computer readable medium 405, and a communication interface 418. The contents of the database 403 are described with respect to the database 123. The communication interface 418 may be connected to the internet and/or other networks 420. The other networks may be a content service provider server and/or a service provider server. Additional, different, or fewer components may be included.

The internet and/or other networks may be in communication with one or more mobile devices and/or one or more application program interfaces (APIs) 270. The one or more API 270 may be in communication with one or more ride share applications.

The communication interface 418 may include any operable connection. An operable connection may be one in which signals, physical connections, and/or logical communications may be sent and/or received. An operable connection may include a physical interface, an electrical interface, and/or a data interface. The communication interface provides for wireless and/or wired communications in any known or later developed format. The communication interface 418 may be connected to the internet and/or other networks. The other networks may be a content provider server or a service provider server. In some embodiments, the communications interface 418 is configured to receive the booked shared vehicle data 201, the user location data 202, user preferences 203, and/or alternative shared vehicle data 204. The communication interface 418 may receive the booked shared vehicle data 201, the user location data 202, the user preferences 203, and/or the alternative shared vehicle data from one or more ride sharing applications, or one or more APIs 270.

The controller may receive the booked shared vehicle data 201, the user location data 202, the user preferences 203, and the alternative shared vehicle data 204 from the communication interface 418. The controller may store the booked shared vehicle data 201, the user location data 202, the user preferences 203, and the alternative shared vehicle data 204 in the database 403 and/or the memory 404 for analysis. The controller may access the database 403 and/or the memory 404 and retrieve the booked shared vehicle data 201, the user location data 202, the user preferences 203, and the alternative shared vehicle data 204.

The booked shared vehicle data 201, the user location data 202, the user preferences 203, and the alternative shared vehicle data 204 may be stored in the database 203 and/or the memory 404.

The memory 404 may be a volatile memory or a non-volatile memory. The memory 404 may include one or more read only memory (ROM), random access memory (RAM), a flash memory, an electronic erasable program read only memory (EEPROM), or other type of memory. The memory 404 may be removable from the apparatus 400, such as a secure digital (SD) memory card.

The memory 404 and/or the computer readable medium 405 may include a set of instructions that can be executed to cause the controller to perform any one or more of the methods or computer-based functions disclosed herein. For example, the controller may monitor for alternative shared vehicles (using the alternative vehicle monitoring module 210). The controller may determine booked shared vehicle suitability data (using the booked vehicle suitability module 220). The controller may determine alternative shared vehicle suitability data (using the alternative vehicle suitability module 230). The controller may compare alternative shared vehicle data to booked shared vehicle data (using the suitability comparison module 240). The controller may issue a command for the communication interface 418 to provide a notification to a user.

In some embodiments, the controller may determine user preferences using the booked shared vehicle data 201, the user location data 202, the user preferences 203, and/or the alternative shared vehicle data 204 of previous trips taken by the user stored in the database 403 and/or memory 404.

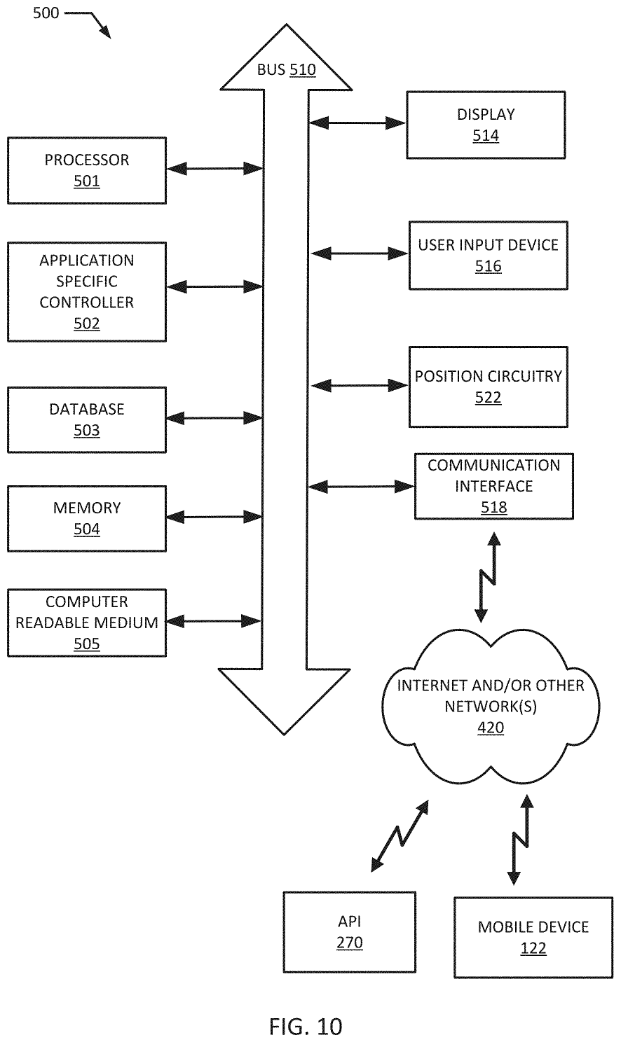

FIG. 10 illustrates an apparatus 500 for assignment of a shared vehicle according to another embodiment of the present disclosure. The apparatus 500 includes a bus 510 facilitating communication between a controller that may be implemented by a processor 501 and/or application specific controller 502, which may be referred to individually or collectively as the controller, and one or more other components including a database 503, a memory 504, a computer readable medium 505, a display 514, a user input device 516, a communication interface 518, and position circuitry 522. The contents of the database 503 are described with respect to the database 123. The communication interface 518 may be connected to the internet and/or other networks 420. The other networks may be a content provider server and/or a service provider server. Additional, different, or fewer components may be included.

The communication interface 518 may include any operable connection. An operable connection may be one in which signals, physical communications, and/or logical communications may be sent and/or received. An operable connection may include a physical interface, an electrical interface, and/or a data interface. The communication interface 418 may be connected to the internet and/or other networks 420. The other networks may be a content provider server or a service provider server. In some embodiments the communication interface 518 is configured to receive the booked shared vehicle data 201, the user location data 202, the user preferences 203, and the alternative shared vehicle data 204. The communication interface 518 may receive the booked shared vehicle data 201, the user location data 202, the user preference 203, and the alternative shared vehicle data 204 from one or more ride sharing applications, or one or more APIs in communication with one or more ride sharing applications.

The controller may receive the booked shared vehicle data 201, the user location data 202, the user preferences 203, and the alternative shared vehicle data 204 from the communication interface 518. The controller may store the booked shared vehicle data 201, the user location data 202, the user preferences 203, and the alternative shared vehicle data 204 in the database 503 and/or the memory 504 for analysis. The controller may access the database 503 and/or memory 504 and retrieve the booked shared vehicle data 201, user location data 202, user preferences 203, and alternative shared vehicle data 204.

The booked shared vehicle data 201, user location data 202, user preferences 203, and alternative shared vehicle data 204 may be store in the database 503 and/or the memory 504.

The memory 504 may be a volatile memory or a non-volatile memory. The memory 504 may include one or more read only memory (ROM), random access memory (RAM), a flash memory, an electronic erasable program read only memory (EEPROM), or other type of memory. The memory 504 may be removable from the apparatus 500, such as a secure digital (SD) memory card.

The memory 504 and/or the computer readable medium 505 may include a set of instructions that can be executed to cause the controller to perform one or more of the methods or computer-based functions disclosed herein. For example, the controller may monitor for alternative shared vehicles (using the alternative vehicle monitoring module 210). The controller may determine booked shared vehicle suitability data (using the booked vehicle suitability module 220). The controller may determine alternative shared vehicle suitability data (using the alternative vehicle suitability module 230). The controller may compare alternative shared vehicle data to booked shared vehicle data (using the suitability comparison module 240). The controller may issue a command for the communication interface 518 to provide a notification to a user. In other examples, the controller may issue a command for the display 514 to provide a notification to the user.

The controller may be operable to allow a user to access and use one or more ride sharing applications on the apparatus 500. For example, the controller may be configured to allow a user to view available shared vehicles, book or reserve a shared vehicle, and/or cancel a booked shared vehicle through one or more ride sharing applications.

A user may use the display 514 and user input device 516 of the apparatus 500 to interact with the one or more ride sharing applications. The display 514 may comprise a screen and the user input device may comprise one or more buttons on the apparatus 500. In some embodiments, the display 51 and user interface may comprise a touch sensitive surface (i.e., a touch screen).

In some embodiments, the apparatus 500 includes position circuitry 522. The position circuitry 522 may collect global navigation satellite system (GNSS) location data of the apparatus 500. The position circuitry may generate GNSS location data by receiving GNSS signals and comparing them to a clock to determine a position of the apparatus 500. In these embodiments, the GNSS location data may be the user location data 202 and the booked shared vehicle suitability module 220 and the alternative shared vehicle module 230 may receive the user location data 202 from the position circuitry 522. The GNSS location data and/or user location data may be stored in the database 503 and/or memory 504.

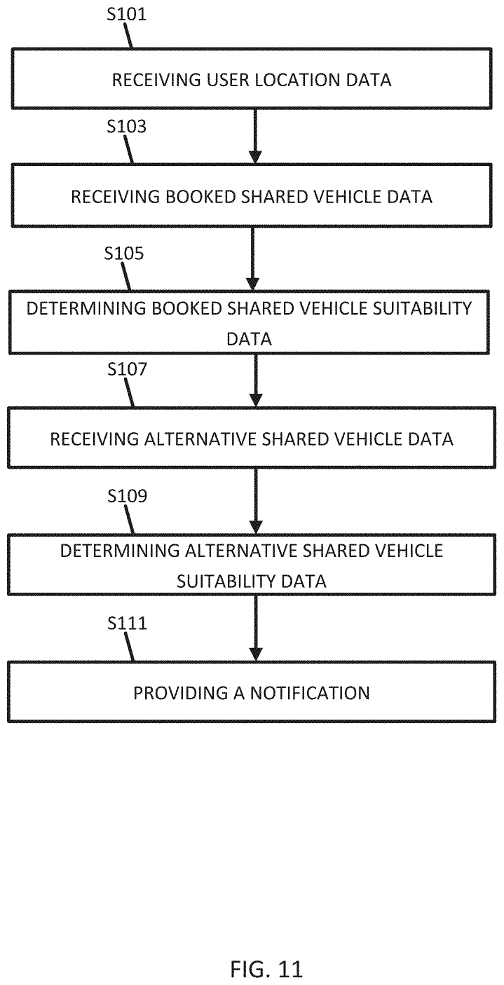

FIG. 11 illustrates an example flow chart for a method of assignment of a shared vehicle according to an exemplary embodiment of the present disclosure. The various systems and apparatuses disclosed herein may employ the method of FIG. 11. Additional, different, or fewer acts may be provided.

At act S101, the system or apparatus receives the user location data 202. In some embodiments, the system or apparatus may be connected to a network (e.g., the internet) and the system or apparatus may receive the user location data 202 via communication over the network. In some embodiments, the user location data 202 may be received through an application program interface (API) connected to the network and configured to communicate with a ride sharing application. In some embodiments, the user location data 202 may be generated by the system or apparatus. In some embodiments, the user location data 202 may be stored in memory and/or a database within the system or apparatus. The user location data 202 may be received from the system or apparatus via the network.

At act S103, the system or apparatus receives the booked shared vehicle data 201. In some embodiments, the system or apparatus may receive the booked shared vehicle data 201 via the network. The booked shared vehicle data 201 may be received through an API connected to the network and configured to communicate with a ride sharing application. The user location data 201 may be stored in memory and/or a database within the system or apparatus. The user location data 201 may be received from the system or apparatus via the network.

At act S105, the booked vehicle suitability module 220 determines the booked vehicle suitability data. The booked shared vehicle suitability data may be determined by the booked vehicle suitability module 220 using the booked shared vehicle data 201 and the user location data 202. In some embodiments, the booked shared vehicle data is determined using the booked shared vehicle data 201, the user location data 202, and the user preferences 203. The booked vehicle suitability module 220 may determine the booked vehicle suitability data as a relevance score and/or a relevance vector.

At act S107, the system or apparatus receives the alternative shared vehicle data 204. In some embodiments, the system or apparatus may receive the alternative shared vehicle data 204 via the network. The alternative shared vehicle data 204 may be received through an API connected to the network and configured to communicate with a ride sharing application. The alternative shared vehicle data 204 may be received through an API from the same ride sharing application as the booked shared vehicle data 201 or through an API connected to a different ride sharing application. The alternative shared vehicle data 204 may be stored in memory and/or a database within the system or apparatus. The alternative shared vehicle data 204 may be received from the system or apparatus through the network.

At act S109, the alternative vehicle suitability module 230 determines the alternative vehicle suitability data. The alternative vehicle suitability data may be determined by the booked vehicle suitability module 230 using the booked shared vehicle data 204 and the user location data 202. In some embodiments, the alternative shared vehicle data is determined using the user location data 202, the user preferences 203, and the alternative shared vehicle data 204. The alternative vehicle suitability module 230 may determine the alternative shared vehicle data as a relevance score and/or a relevance vector.

At act S111, a notification is provided to a user based on a comparison of the alternative shared vehicle suitability data to the booked shared vehicle suitability data. A suitability comparison module 240 may compare the alternative shared vehicle suitability data to the booked shared vehicle suitability data.

In embodiments where the booked vehicle suitability data and the alternative vehicle suitability data are determined using a relevance score, when the relevance score for the alternative shared vehicle exceeds the relevance score for the booked shared vehicle the notification may be a notification that a more suitable alternative shared vehicle is available. The notification may provide the user with an option to cancel the initially booked shared vehicle and reserve the alternative shared vehicle. In some embodiments, the notification may bring the user to a ride sharing application to reserve the alternative shared vehicle. In other embodiments, the notification may bring the user to a ride sharing application to cancel the booked shared vehicle. In some embodiments, the notification may bring the user to an application to both cancel the initial booked shared vehicle and reserve the alternative shared vehicle.

In embodiments where the booked vehicle suitability data and the alternative vehicle suitability data are determined using a relevance score, when the relevance score for the alternative shared vehicle exceeds the relevance score for the booked shared vehicle the notification may be a notification that the initial booked shared vehicle has been cancelled and that an alternative shared vehicle has been reserved. In other words, the alternative shared vehicle may automatically be reserved without providing an option to reserve the alternative shared vehicle or keep the initial booked shared vehicle.

If the booked vehicle relevance score exceeds the alternative vehicle relevance score a notification may not be provided at the user.

In embodiments where the booked vehicle suitability data and the alternative vehicle suitability data are determined using the relevance vector, when the relevance vector indicates that an alternative shared vehicle is a suitable vehicle and a booked shared vehicle is not a suitable vehicle, the notification may be a notification that a more suitable alternative shared vehicle is available. The notification may provide the user with an option to cancel the initial booked shared vehicle and reserve the alternative shared vehicle. In some embodiments, the notification may bring the user to a ride sharing application to reserve the alternative shared vehicle. In other embodiments, the notification may bring the user to a ride sharing application to cancel the booked shared vehicle. In some embodiments, the notification may bring the user to an application to both cancel the initial booked shared vehicle and reserve the alternative shared vehicle.

In embodiments where the booked vehicle suitability data and the alternative vehicle suitability data are determined using the relevance vector, when the relevance vector indicates that an alternative shared vehicle is a suitable vehicle and a booked shared vehicle is not a suitable vehicle, the notification may be a notification that the initial booked vehicle has been cancelled and the alternative shared vehicle has been reserved. In other words, the alternative shared vehicle may be automatically reserved without providing the user with an option to reserve the alternative shared vehicle or keep the initial booked shared vehicle.

In cases where the alternative shared vehicle vector relevance indicates that the alternative shared vehicle is not suitable or where both the alternative shared vehicle vector relevance and the booked shared vehicle vector relevance indicate that both the alternative shared vehicle and the booked shared vehicle are suitable, a notification may not be provided to the user.

In embodiments where a notification is provided to a user and the notification provides a user the option to keep a booked shared vehicle or reserve an alternative shared vehicle and cancel the booked shared vehicle, the notification may allow a user to decide between keeping the booked shared vehicle and reserving the alternative shared vehicle with one click or one interaction with the apparatus or system. After the click or interaction, the system or apparatus may automatically keep the booked shared vehicle or reserve the alternative shared vehicle and cancel the book shared vehicle according to the user's selection.

In some embodiments, the notification provided to a user may include the relevance score of the booked shared vehicle and the relevance score of the alternative shared vehicle.

The method for assignment of a shared vehicle according to the present disclosure may additionally include a step of receiving the user preferences 203. In some embodiments the system or apparatus may receive the user preferences 203 via the network. In other embodiments, the system or apparatus may generate the user preferences 203. The system or apparatus may generate the user preferences by prompting the user to enter the user preferences into the system or apparatus. The user preferences may be received through an API connected to the network and configured to communicate with a ride sharing application. The user preferences 203 may be stored in memory and/or a database within the system or apparatus. The user preferences 203 may be received by the system or apparatus through the network.

In some embodiments, a method of assignment of a shared vehicle may further include an act of monitoring an area for alternative shared vehicles. An alternative vehicle monitoring module 210 may monitor a vicinity surround a user and/or a vicinity between the user and the users destination for alternative shared vehicles that may be more suitable than the booked shared vehicle.

In some embodiments, a method for assignment of a shared vehicle may further include an act of booking that alternative shared vehicle based on a comparison of the alternative shared vehicle suitability data to the booked shared vehicle suitability data.

In some embodiments, a method for assignment of a shared vehicle may further include an act of cancelling the booked shared vehicle after an alternative shared vehicle has been booked.

In some embodiments, a method for assignment of a shared vehicle may further include an act of storing ride data including user location data, booked shared vehicle data, and alternative shared vehicle data. In this embodiment, the method may further include an act of accessing the previous ride data to generate user preferences used in determining the booked shared vehicle suitability data and alternative shared vehicle suitability data.

The system or apparatus for assignment of a shared vehicle may further be connected to one or more sources of information or applications via the network. For example, the system or apparatus may receive weather information corresponding with a location of the user through communication with the sources of information or applications. The system or apparatus may receive weather information, traffic information, and the like from the one or more sources of information and/or applications. The one or more sources of information and/or applications may communicate with the system or apparatus via the network using one or more APIs.

The system and apparatus may further include or be connected to memory and/or a database storing geographic information related to the surroundings of the user. The memory or database may include a map of the vicinity surrounding the user including the streets and/or intersection in the vicinity of the user and along a route the user may take to reach a destination. The memory and/or database may contain information including routes that are or are not accessible to one or more shared vehicle types and the like. The system or apparatus may communicate with the memory and/or database via the network.

The method for assignment of a shared vehicle may continue to repeat itself until a user reaches the shared vehicle or until a user reaches their destination. In other words, the system or apparatus may continue to receive alternative shared vehicle data 204, determine alternative vehicle suitability data, compare booked vehicle suitability data and alternative vehicle and suitability data, and provide notifications to a user until the user reaches a booked vehicle or until a user reaches their destination.

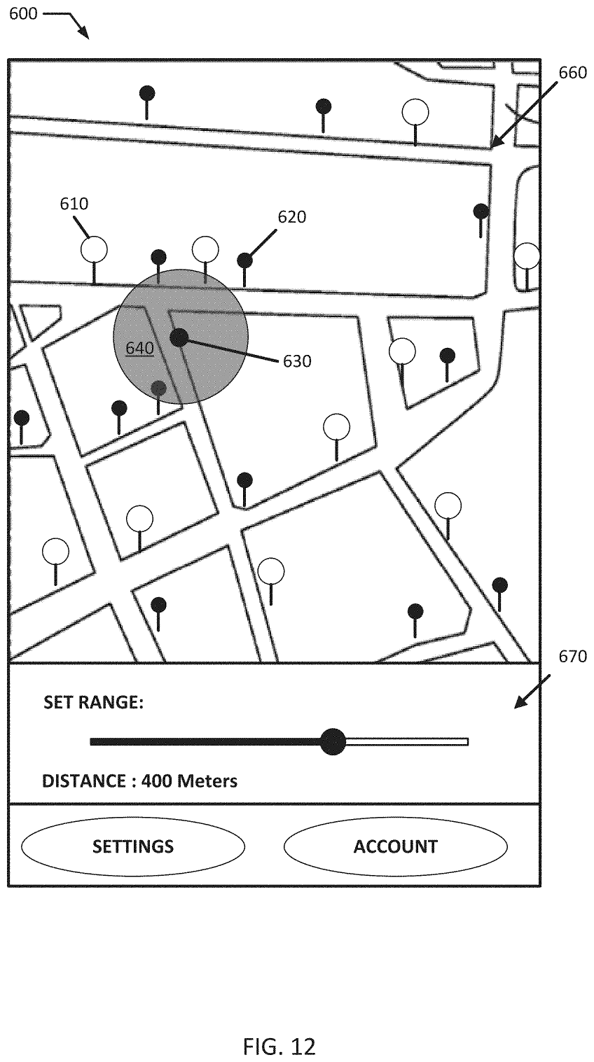

FIGS. 12-15 illustrate a graphic user interface for an apparatus for assignment of a shared vehicle during several states that may occur during assignment of a shared vehicle according to an embodiment of the present disclosure. In some embodiments the apparatus for assignment of a shared vehicle may be a mobile device, such as a smartphone.

FIG. 12 is an example of a graphic user interface 600 of an apparatus for assignment of a shared vehicle according to an embodiment of the present disclosure. In some embodiments, the apparatus may be a mobile device, such as a smartphone. FIG. 12 illustrates a graphic user interface 600 before a user has selected a shared vehicle. The graphic user interface 600 of FIG. 12 includes a map 660, an available shared vehicle from a first ride share provider 610, a user location 630, and a user selected radius 640. In some embodiments, the graphical user interface includes one or more available shared vehicles from a second ride share provider 620.

The user interface includes a map 660 and a user setting portion 670. The map 660 includes the user location 630, the user selected radius 640, one or more available shared vehicles from a first ride share provider 610. In some embodiments, the map further includes one or more available shared vehicles from a second ride share provider 620.

The user setting portion 670 of the graphic user interface 600 includes one or more icons that the user can interact with. When a user interacts with the one or more icons in the user setting portion 670, the user may change settings for the assignment of a shared vehicle. For example, a user may change the user selected radius 640. The user selected radius 640 may be a vicinity surrounding the user which is monitored for alternative shared vehicles. The icon used to change the user selected radius 640 may be slider. For example, the icon may be a bar including another icon, in the example of FIG. 12 a circle. A user may slide the second icon, here a circle, along the bar to change the radius of the user selected radius. The user setting portion 670 may allow a user to input user preferences 203. The user setting portion 670 may allow a user to access their account settings.

The user setting portion 670 may contain icons that when interacted with allow a user to access one or more different screens. The one or more different screens may allow a user to change more settings. The one or more different screens may allow the user to enter user preferences 203. The one or more different screens may include screens for a user to view and/or change account information.

The map 660 includes shows an area surrounding a user. The map may include the streets and intersections within a vicinity of the user. In some embodiments, the graphical user interface 600 may be operable to allow a user to zoom in and out on the map. In some embodiments, the graphical user interface 600 may be operable to allow a user to move the map 660 to show a different area. The map includes the user location 630 and the user selected radius 640 surrounding the user location 630. Further, the map 660 includes one or more available shared vehicles from a first ride share provider 610. The map 660 may additionally include one or more available shared vehicles from a second ride share provider 620. The map may only include available vehicles from one ride share provider, if no shared vehicles are available from a second provider within the area of the map shown on the graphical user interface 600. In some embodiments, the map may include available shared vehicles from three or more ride share providers.

In a first state of the graphical user interface 600, as shown in FIG. 12, a shared vehicle has not been booked. In the first state, the map 660 includes multiple available shared vehicles from a first ride share provider 610 and multiple available shared vehicles from a second ride share provider 620. In the first state, the graphical user interface 600 is operable to allow a user to select the available vehicles from a first ride share provider 610 and the available shared vehicles from a second ride share provider 620.

When a user selects an available shared vehicle, the user graphical user interface may show the user various information about the shared vehicle. For example, a type of the shared vehicle may be displayed, various features of the shared vehicle may be displayed, and/or a range of the shared vehicle. In some embodiments, upon selecting an available shared vehicle, the user may also select a destination for the trip on the map. Upon selecting a destination for the trip, the graphical interface may determine and display a price of the shared vehicle for the trip, whether a detour must be taken and the length of a detour to me taken. The graphic user interface 600 may display any of a vehicle location, a distance from the shared vehicle to a destination, routes that the vehicle is capable of taking, a vehicle safety rating, how and where the vehicle may be parked at the destination, and the like.

Additionally, after selecting an available shared vehicle, the graphical user interface allows the user to book the available shared vehicle.

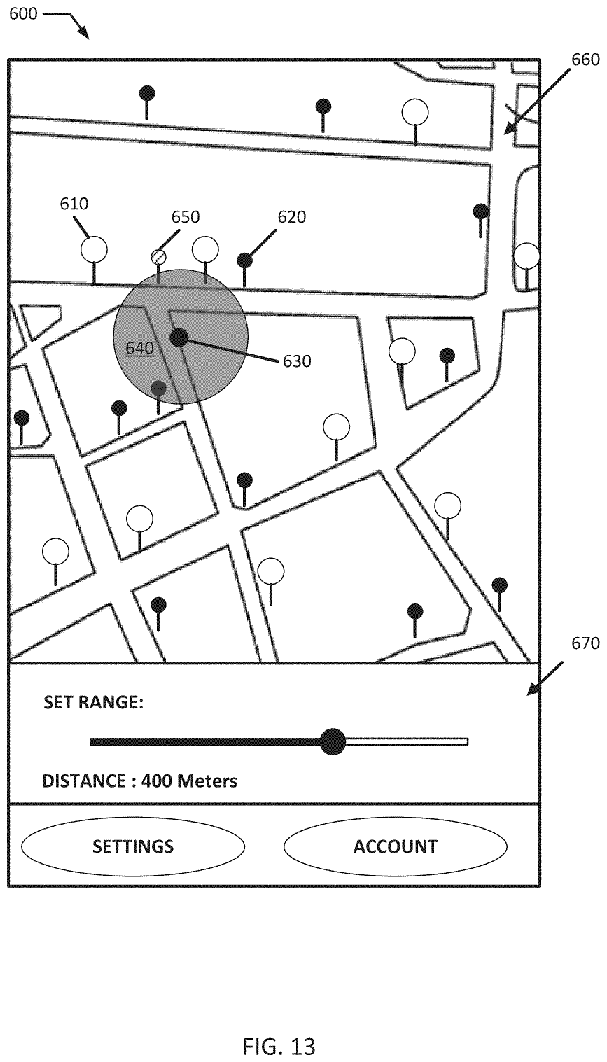

FIG. 13 illustrates the graphical user interface 600 in a second state in which a shared vehicle has been booked. The graphical user interface 600 displays the booked shared vehicle 650 on the map 660. After a vehicle has been booked, the user selected radius 640 is monitored alternative shared vehicles. The user selected radius 640 may be monitored for shared vehicles located within the user selected radius at the time that a shared vehicle is booked. Additionally, the user selected radius 640 is monitored for available shared vehicles that arrive in the user selected radius 640 after a shared vehicle is booked. The alternative shared vehicle monitoring module 210 may monitor the user selected radius for alternative shared vehicles.

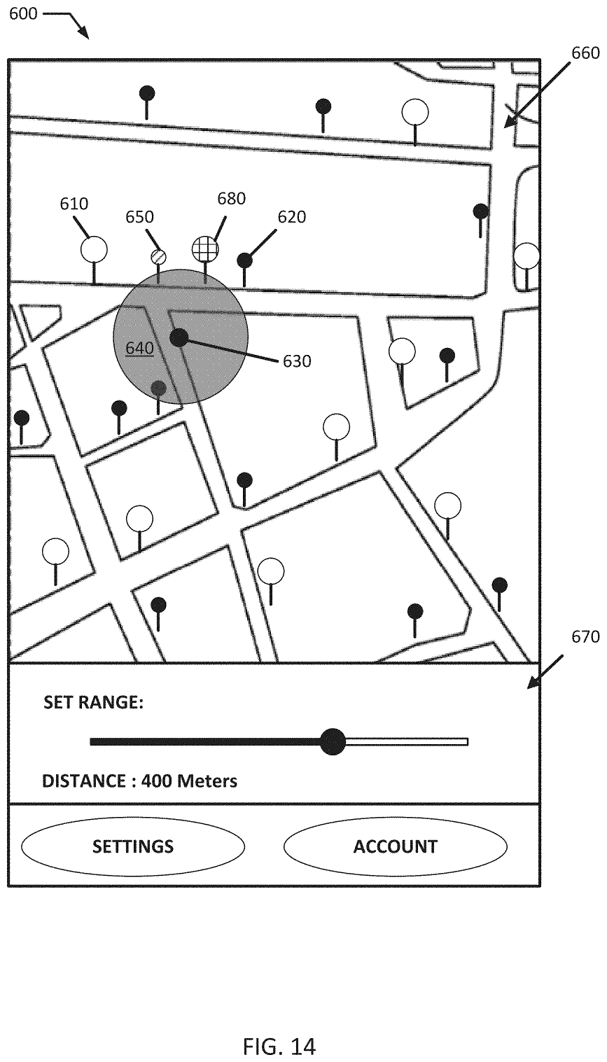

FIG. 14 illustrates the graphical user interface 600 in a third state in which a shared vehicle has been booked and in which an alternative shared vehicle 680 has been identified. The graphical user interface 600 displays the alternative shared vehicle 680 on the map 660. The alternative shared vehicle 680 may be an available shared vehicle from a first ride share provider 610 or an available shared vehicle from a second ride share provider 620. In some embodiments, when shared vehicles are available from three or more ride share providers, the alternative shared vehicle may be from any of the three or more ride share providers.

When an alternative shared vehicle 680 has been identified, the alternative vehicle suitability data is determined. The alternative vehicle suitability module 230 may determine the alternative shared vehicle suitability data using the alternative shared vehicle data 204, and the user location data 202. In some embodiments, the user preferences 203 are also used to determine the alternative shared vehicle suitability data. The alternative shared vehicle suitability data may comprise a relevance score, and/or a relevance vector.

When an alternative shared vehicle 680 has been identified, the booked shared vehicle suitability data is determined. The booked vehicle suitability module 220 may determine the booked vehicle suitability data using the booked shared vehicle data 201, and the user location data 202. In some embodiments, the user preferences 203 are also used to determine the booked shared vehicle suitability data. The alternative shared vehicle data may comprise a relevance score and/or a relevance vector.

The suitability comparison module 240 then compares the booked shared vehicle suitability data and the alternative shared vehicle suitability data. The suitability comparison module 240 may compare the booked vehicle suitability data and the alternative vehicle suitability data as described herein with respect to the embodiment of FIG. 1. Further, the suitability comparison module 240 may determine whether a notification is provided to a user as disclosed herein with respect to the embodiment of FIG. 1.

When it is determined that a notification is to be provided to the user, a user ma receive the notification on the graphical user interface 600. The notification may be a notification informing the user that a more suitable alternative shared vehicle is available. In some embodiments, the more suitable alternative shared vehicle may be automatically reserved, and the booked shared vehicle may be automatically cancelled.

In embodiments where the notification informs a user that a more suitable shared vehicle is available, and a user selects the notification, the notification may bring the user to the graphical user interface as shown in FIG. 14. The user may then select the booked shared vehicle 650 and the alternative shared vehicle 680 on the graphical user interface 600. Upon selecting the booked shared vehicle 650, the graphical user interface 600 may provide the user with an option to cancel the booked shared vehicle 650. Upon selecting the alternative shared vehicle 680, the graphical user interface 600 may provide the user with an option to reserve the alternative shared vehicle. In some embodiments, reserving the alternative shared vehicle 680 may automatically cancel the initially booked shared vehicle 650.

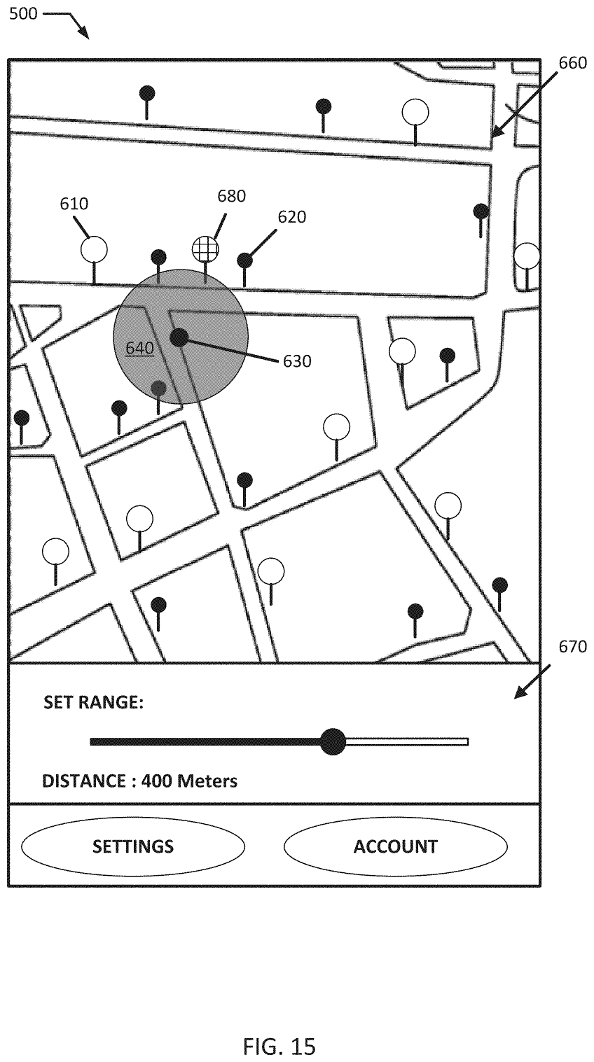

FIG. 15 illustrates the graphic user interface 600 in a fourth state in which an initially booked shared vehicle 650 has been cancelled and an alternative shared vehicle 680 has been reserved. After an alternative shared vehicle 680 has been reserved or an initially booked vehicle has been kept, the alternative vehicle monitoring module 210 may continue to monitor for alternative shared vehicles.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable medium suitable for storing computer program instructions and data include all forms of non-volatile memory, medium and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In an embodiment, a vehicle may be considered a mobile device, or the mobile device may be integrated into a vehicle.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “computer-readable medium” includes a single medium or multiple medium, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor medium, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other

The descriptions and illustrations of the embodiments provided herein are intended to provide a general understanding of the structure of the various embodiments. The descriptions and illustrations are not intended to serve as a complete description of all of the elements and features of apparatuses and systems that utilize the structure or methods described herein. Many other embodiments may be apparent to those having ordinary skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other portions may be minimized. Accordingly, the disclosure and the figures are to be regarded as illustrative rather than restrictive.

While this specification contains many specifics, these should not be constructed as limitations on the scope of the present inventive concept or of what may be claimed, but rather as descriptions of features specific to particular embodiments of the inventive concept. Certain features that are disclosed herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various systems components in the embodiments described above should not be understood as requiring such separation in all embodiments.

When a component, device, element, or the like of the present disclosure is described as having a purpose or performing an operation, function, or the like, the component, device, or element should be considered herein as being “configured to” meet that purpose or to perform that operation or function.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. The disclosure is intended to cover any and all subsequent adaptations or variations of various embodiments. Combinations of the above embodiments, and other embodiments not specifically described herein, are apparent to those of skill in the art upon reviewing the disclosure.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A method for assignment of a shared vehicle, the method comprising:
receiving user location data;
receiving booked shared vehicle data for a booked shared vehicle;
determining booked shared vehicle suitability data for the booked shared vehicle using the user location data and the booked shared vehicle data;
receiving alternative shared vehicle data for an alternative shared vehicle;
determining an alternative shared vehicle suitability data using the user location data and the alternative shared vehicle data; and
providing a notification to a user based on a comparison of the alternative shared vehicle suitability data to the booked shared vehicle suitability data.

2. The method of claim 1, wherein the vehicle suitability data includes a relevance score calculated using inputs determined from the user location data and the booked shared vehicle or the alternative shared vehicle data,
wherein the inputs are weighted to determine a relevance score for the booked shared vehicle or the alternative shared vehicle.

3. The method of claim 2, wherein the inputs include a distance from the user to the booked shared vehicle or alternative shared vehicle, type of booked vehicle or alternative shared vehicle, weather, distance from the booked shared vehicle or alternative shared vehicle to a destination, and a price of a booked shared vehicle or an alternative shared vehicle or a combination thereof.

4. The method of claim 1, wherein the vehicle suitability data includes a relevance vector including components determined from the user location data and the booked shared vehicle data or alternative shared vehicle data,
wherein one or more of the components of the relevance vector individually or collectively determine the relevance vector.

5. The method of claim 4, wherein the components include a distance from the user to the booked shared vehicle or alternative shared vehicle, type of booked vehicle or alternative shared vehicle, weather, distance from the booked shared vehicle or alternative shared vehicle to a destination, and a price of a booked shared vehicle or an alternative shared vehicle or a combination thereof.

6. The method of claim 1, further comprising:
receiving user preferences,
wherein the booked shared vehicle suitability data and the alternative shared vehicle suitability data are based on the user preferences.

7. The method of claim 6, wherein the vehicle suitability data includes a relevance score calculated using inputs determined from the user location data, the user preferences and the booked shared vehicle data or the alternative shared vehicle data,
wherein the inputs are weighted to determine a relevance score for the booked shared vehicle or the alternative shared vehicle.

8. The method of claim 6, wherein the vehicle suitability data includes a relevance vector including components determined from the user location data, the user preferences, and the booked shared vehicle data or alternative shared vehicle data,
wherein one or more of the components of the relevance vector may individually or collectively determine the relevance vector.

9. The method of claim 6, wherein the user preferences include a preferred vehicle type, a preferred vehicle provider, or a preferred vehicle route.

10. The method of claim 1, further comprising:
monitoring an area for alternative shared vehicles.

11. The method of claim 10, further comprising:
booking the alternative shared vehicle based on a comparison of the alternative shared vehicle suitability data to the booked shared vehicle suitability data; and
cancelling the booked shared vehicle after the alternative shared vehicle has been booked,
wherein the notification provided to a user notifies the user that an alternative shared vehicle has been booked.

12. The method of claim 1, further comprising:
providing the user an option to cancel the booked shared vehicle and book the alternative shared vehicle,
wherein the notification provided to the user notifies the user that an alternative shared vehicle is available.

13. The method of claim 1, wherein the booked shared vehicle data includes a booked shared vehicle location and a booked shared vehicle type.

14. The method of claim 13, wherein the book shared vehicle data further includes a booked shared vehicle price, a distance from a booked shared vehicle to a destination, a booked shared vehicle route, a booked shared vehicle safety rating, a booked shared vehicle range, or a combination thereof.

15. The method of claim 1, wherein the user location data includes a location of a user and weather at the location of the user.

16. The method of claim 1, further comprising:
storing ride data including user location data, booked shared vehicle data, and alternative shared vehicle data; and
accessing the ride data to generate user preferences used in determining the booked shared vehicle suitability data and alternative shared vehicle suitability data.

17. The method of claim 1, wherein the user location data, booked shared vehicle data, and alternative shared vehicle data are received from one or more application program interfaces connected to one or more ride sharing applications.

18. An apparatus for assignment of a shared vehicle, the apparatus comprising:
a communication interface configured to receive user location data, booked shared vehicle data for a booked shared vehicle, and alternative shared vehicle data for an alternative shared vehicle;
a memory configured to store the user location data, the booked shared vehicle data, and the alternative shared vehicle data; and
a processor configured to access the memory, determine a booked shared vehicle suitability data using the user location data and booked shared vehicle data, determine an alternative shared vehicle suitability data using the user location data and the alternative shared vehicle data, and provide a notification to a user based on a comparison of the alternative shared vehicle suitability data to the booked shared vehicle suitability data.

19. The apparatus of claim 18, wherein the vehicle suitability data includes a relevance score calculated using inputs determined from the user location data and the booked shared vehicle or the alternative shared vehicle data,
wherein the inputs are weighted to determine a relevance score for the booked shared vehicle or the alternative shared vehicle.

20. An apparatus for assignment of a shared vehicle, the apparatus comprising:
a communication interface configured to receive user location data, booked shared vehicle data for a booked shared vehicle, and alternative shared vehicle data for an alternative shared vehicle;
a memory configured to store the user location data, the booked shared vehicle data, and the alternative shared vehicle data;
a user interface; and
a processor configured to access the memory, determine a booked shared vehicle suitability data using the user location data and booked shared vehicle data, and determine an alternative shared vehicle suitability data using the user location data and the alternative shared vehicle data,
wherein the user interface is configured to provide a notification to a user based on a comparison of the alternative shared vehicle suitability data to the booked shared vehicle suitability data.
